(19) United States
(12) Patent Application Publication
(10) Pub. No.: US 2009/0020937 A1
(43) Pub. Date: Jan. 22, 2009

(54) Vise understop

(76) Inventor: Gary Odell, Fremont, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/880,379

(22) Filed: Jul. 19, 2007

(51) Int. Cl. B25B 1/24

(52) U.S. Cl. 269/271

(57) ABSTRACT

A vice understop comprising an understop body and a relocatable stop connected to the understop body is removably attached with clamping screws to a hard jaw of a machine vise to establish a reference position for a work piece to be machined. A vise block placed against a front surface of the vise understop establishes a vertical reference position for the work piece. A locating pin on the relocatable stop is adapted for a sliding fit into an aperture on the understop body and a curved surface on the relocatable stop contacts a correspondingly curved support shoulder on the understop body. A position of the relocatable stop selected from a plurality of discrete positions on the understop body establishes a horizontal reference position for the work piece. A locating post on a back surface of the understop body enables accurate, repeatable positioning of the vise understop against the hard jaw.

### FIELD OF THE INVENTION

The present invention relates generally to a device for positioning a work piece in a vise and more specifically to a device for selectively positioning a work piece relative to a hard jaw of a machine vise.

### BACKGROUND

In some machining operations, a rotating cutting tool selectively removes material from a work piece held on a table on a machine tool. The work piece may be held on the table by a holding means such as a clamp, a vise, a purpose-built fixture, or other positioning or restraining devices. Some examples of a machine tool having a table on which a work piece is held are horizontal mills, vertical mills, grinders, drill presses, and computer numerical control (CNC) mills. The holding means aids safe and accurate machining by limiting work piece slippage while the work piece and cutting tool are in contact with each other. For CNC mills, which are well adapted for repetitive machining operations as may occur in high volume production, the holding means may also facilitate rapid and accurate replacement of one work piece with another.

Configuring a holding means for a machining task may involve substantial labor time and material expense and may contribute to a significant fraction of the finished cost of a machined product. In some cases, a purpose-built fixture may provide the best accuracy and fastest work piece setup, but design, fabrication, validation, and storage costs are usually higher for a purpose-built fixture than for other holding means. Furthermore, a purpose-built fixture may require extensive modification or may even be scrapped entirely should a change be made to the machined product.

Holding means comprising toggle clamps, modular clamps, V-blocks, and other multi-purpose holding and positioning devices are adaptable to a variety of machining projects. However, the time to set up a holding means with multi-purpose holding and positioning devices may be substantial, and removing a work piece from the holding means and replacing it with another work piece may be inconvenient or time consuming. The accuracy of such a holding means is subject to the skill of the person setting it up, and the accuracy may vary from one work piece placement to the next. Furthermore, care must be taken to ensure that the various components comprising the holding means do not interfere with a desired path of a cutting tool.

A holding means comprising a vise may provide an amount of accuracy, an economy of set up, and an ease of changing work pieces that is intermediate between a purpose-built fixture and multi-purpose holding and positioning devices. Many kinds of vises are available. A type of vise known as a machine vise comprises a fixed jaw and a floating jaw that is moved relative to the fixed jaw by a floating jaw positioning mechanism. Some machine vises have a floating jaw positioning mechanism with a manually-operated screw. Other machine vises have a floating jaw positioning mechanism that is electrically or hydraulically driven. In some machine vises, a hard jaw attached to a face of the floating jaw and another hard jaw attached to a face of the fixed jaw provide accurate surfaces and edges for locating and holding a work piece. The work piece is held firmly in place by a compression force generated between opposing faces of the hard jaws on the floating jaw and fixed jaw. The magnitude of the compression force may be changed by an adjustment of the floating jaw positioning mechanism. The fixed jaw is attached to a base which houses the floating jaw positioning mechanism. The base of the vise may be formed with apertures or flanges for attaching the vise to a table on a machine tool.

Devices for positioning a work piece relative to the jaws of a machine vise are known in the art. A vise parallel is an example of such a positioning device. A vise parallel may be a metallic rectangular solid having a first and a second planar face formed parallel to each other and perpendicular to a third planar face. A separation distance across a narrow dimension of the first or second planar face is referred to as a height of a vise parallel. Vise parallels are generally used in pairs having matching heights. A first vise parallel is placed in contact with a face of a hard jaw attached to a fixed vise jaw and a second vise parallel is placed in contact with a face of a hard jaw attached to a floating vise jaw. A work piece may optionally be placed between the fixed vise jaw and floating vise jaw with a bottom surface of the work piece in contact with a top surface of the first vise parallel and a top surface of the second vise parallel, the height of the vise parallels defining a vertical reference position for the work piece. Vise parallels are held against the hard jaws by an expansion spring placed in the space between the vise parallels, by one or more spring posts having an expansion spring and a cylindrical portion with a shoulder which engages a hole in a vise parallel and presses the vise parallel against a hard jaw, by magnetic means, or by other removable attachment means.

Vise parallels are often used to define a vertical reference position for a work piece held in a vise, but other means have generally been used to define a lateral reference position for the work piece. A convention followed herein defines a lateral direction as a direction parallel to a transverse dimension of a vise and a vertical direction as a direction perpendicular to a table surface. Reference locations from which position measurements may be made include, but are not limited to, an edge of a cutting tool, an edge of a hard jaw, a surface on a table, or another object having a surface or edge with a known or trusted position or known deviation from an ideal shape, such as deviation from a straight line or deviation from an ideal plane. Other locating devices known in the art provide a lateral reference position with an error of about 0.002 inch (0.051 millimeter) or more for repeated placement of a work piece. A repeatability error of 0.002 inch is large compared to the best accuracy available from many modern machine tools. Separate clamps are sometimes added to a machining set up using vise parallels to provide a lateral reference position, or an alignment procedure may be performed each time a new work piece is placed in the holding means. Adding more clamps increases the time to set up a holding means and increases the number of obstacles that may interfere with a preferred cutting tool path. Alignment procedures may be time consuming and are subject to the skill of the person performing them.

What is needed is a device for establishing a reference position of a work piece that attaches rapidly and securely to a machine vise, has a repeatable positioning error of 0.0002 inch (0.0051 millimeter) or less, establishes a range of vertical reference positions for a work piece with vise parallels having a range of heights, and minimizes interference with cutting tool paths.

### SUMMARY

A vise understop attaches to a hard jaw of a machine vise and establishes a selectable reference position for a work piece held in the machine vise. The vise understop comprises a flat front surface against which a vise parallel is held. A top surface of the vise parallel establishes a vertical reference position for a work piece placed in contact with the top surface. The vise understop further comprises a relocatable stop removably connected to an understop body. A lateral position of the relocatable stop may be selected from a plurality of discrete positions formed along a length of the understop body. A vertical surface on a side of the relocatable stop establishes a lateral reference position for a work piece placed in contact with the vertical surface.

The understop body comprises a back side formed with a rectangular channel having a long dimension adapted for a loose clearance fit of a hard jaw. In some embodiments, at least one locating post is attached to the back side of the understop body. The locating post has a position and a size adapted to fit inside the aperture of a socket head threaded fastener used to attach a hard jaw to a vise jaw.

In one embodiment, a shoulder on a front side of the understop body and a corresponding surface on the relocatable stop have a profile in the shape of a serpentine curve. Other embodiments have a shoulder on the understop body and a corresponding surface on the relocatable stop that is alternatively flat, crenellated, or other shapes. A face on the front side of the understop body is formed with a plurality of apertures adapted for a close sliding fit of a pin attached to the relocatable stop. Contact between a pin on the relocatable stop with a wall of an aperture in the understop body and further contact between the shoulder of the understop body and the corresponding surface on the relocatable stop cooperate to establish a stable, secure, and repeatable lateral reference position for the relocatable stop and correspondingly for a work piece placed in contact with the relocatable stop.

In some embodiments, a channel is formed in a right side of the understop body. The channel is adapted for a clearance fit of a shaft of a spring post used to press a vise parallel against a surface. Another channel may optionally be formed in a left side of the understop body. The right and left sides may also be formed with threaded apertures through which compression screws are cooperatively assembled. An adjustment of the compression screws holds the vise understop firmly in contact with a hard jaw. Tightening a compression screw against a hard jaw also causes the locating post on the back side of the understop body to firmly contact a wall of an aperture in a socket head threaded fastener used to attach a hard jaw to a vise jaw, thereby limiting an amount by which the understop body may move relative to the hard jaw and correspondingly improving the accuracy and repeatability of a positioning reference for a work piece.

This section summarizes some features of the present embodiment. These and other features, aspects, and advantages of the embodiments of the invention will become better understood with regard to the following description and upon reference to the following drawings, wherein:

### BRIEF DESCRIPTION OF THE DRAWINGS

FIG. 1 is a pictorial view of an embodiment of a vise understop.

FIG. 2 is a pictorial view of an example of a machine vise.

FIG. 3 is a top view of an embodiment of an understop body.

FIG. 4 is a front view of the embodiment of FIG. 3.

FIG. 5 is a side view the embodiment of FIG. 3 and FIG. 4.

FIG. 6 is a front view of an example of a relocatable stop.

FIG. 7 is a side view of the embodiment of FIG. 6.

FIG. 8 is an example of a vise understop in position against a face of a vise hard jaw.

FIG. 9 is a sectional view along line A-A of the vise understop and vise hard jaw of FIG. 8.

FIG. 10 illustrates an example of a vise understop attached to a hard jaw on a machine vise.

FIG. 11 shows an example of two parallels being supported by a floating vise jaw and by the vise understop from FIG. 10.

FIG. 12 shows an example of a work piece positioned against the hard jaws, parallels, and vise understop from FIGS. 10 and 11.

### DESCRIPTION

Embodiments of the invention include a device intended to establish a reference position for a work piece held in a vise. Devices built in accord with the invention are particularly suited for use with a machine vise, but other kinds of vises may also be used. Some of the benefits of the embodiments of the invention include, but are not limited to, rapidity and simplicity of installation, small positioning error, good repeatability, minimal interference with preferred cutting tool paths, suitability for a variety of machine tools and work pieces, stable support for vise parallels having a range of a height dimension, and ease of adaptation to vises of various styles and sizes.

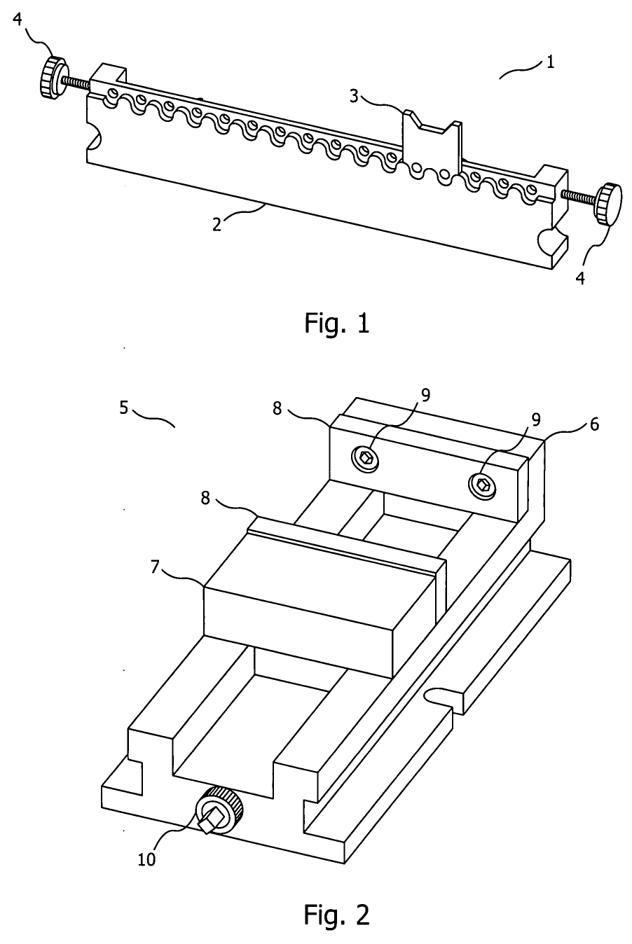

An embodiment of a vise understop adapted for attachment to a hard jaw on a machine vise is shown in FIG. 1. The vise understop 1 of FIG. 1 comprises an understop body 2, a relocatable stop 3, a clamping screw 4 on a right side of the understop body 2, and a clamping screw 4 on a left side of the understop body 2. The understop body 2 couples to the hard jaw and supports other elements that establish a position reference for a work piece. The clamping screws 4 are adjusted to press on opposite sides of a vise hard jaw and aid in holding the vise understop 1 firmly against a face of the hard jaw. The relocatable stop 3 establishes a lateral reference position for a work piece placed in contact with a vertical edge on a side of the relocatable stop 3. In the embodiment shown, the relocatable stop 3 is removably attached to the understop body 2 and has a position which may be selected from among a plurality of discrete positions formed along a length of the understop body 2.

An example of a machine vise on which a vise understop 1 may be used is illustrated in FIG. 2. A vise understop may be used with other sizes and styles of vises. The machine vise 5 includes a fixed vise jaw 6, a floating vise jaw 7, and a floating jaw positioning mechanism 10. An adjustment of the floating jaw positioning mechanism 10 causes a displacement along a long axis of the vise 5 of the floating vise jaw 7 relative to the fixed vise jaw 6, thereby changing a separation distance between the hard jaws 8 attached to the vise jaws (6, 7). A hard jaw 8 is attached to the fixed vise jaw 6 with a socket head threaded fastener 9. Another hard jaw 8 is attached to the floating vise jaw 7 with a socket head threaded fastener 9 (not illustrated). In the example of FIG. 2, a hard jaw 8 is attached to the fixed jaw 6 with two socket head threaded fasteners 9. Other machine vises may use a different number or location of socket head threaded fasteners.

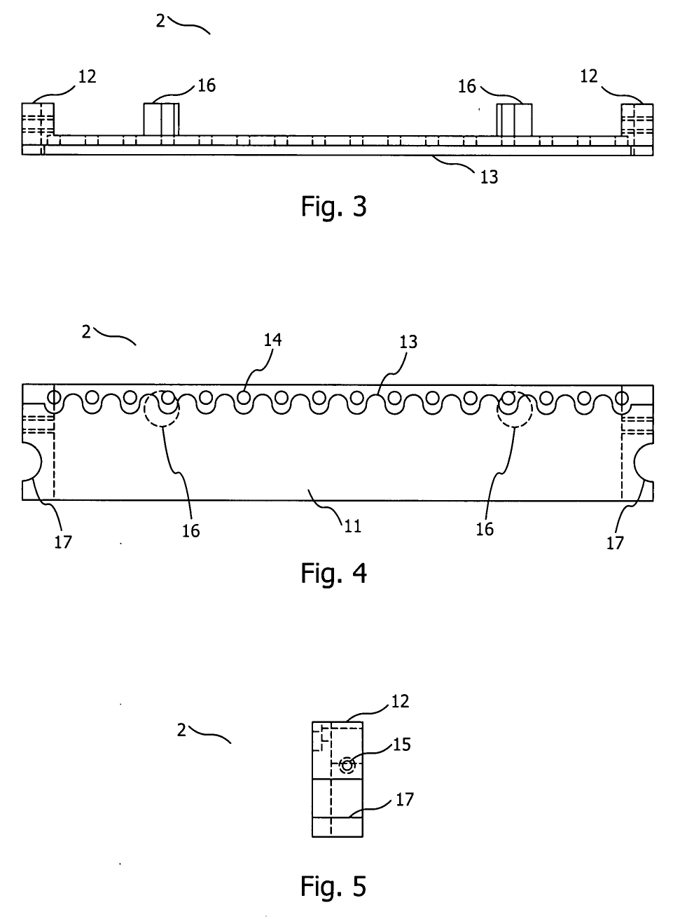

A function of the understop body 2 is to support other elements used to establish a lateral reference position and optionally a vertical reference position for a work piece held against a hard jaw in a machine vise. The understop body 2, shown in a top view in FIG. 3, in a front view in FIG. 4, and in a right side view in FIG. 5, comprises a front surface 11 having a straight bottom edge and a curved top edge near the uppermost surface of the understop body 2. The curved top edge is an edge of a relocatable stop support shoulder 13. A left side of the understop body 2 comprises an understop side flange 12. A right side of the understop body 2 comprises another understop side flange 12. A preferred separation distance between an inner surface of the right-side understop side flange 12 and an inner surface of the left-side understop side flange 12 is slightly larger than a length dimension of a preferred hard jaw. In one embodiment, the separation distance between the inner surfaces of the right-side and left-side understop side flanges 12 is 6.05 inches (153.7 millimeters). Other embodiments have other values for the separation distance between side flanges.

A locating post 16 extends perpendicularly from a back surface of the understop body 2, as shown in FIG. 3. The locating post 16 limits a relative motion between the understop body 2 and a hard jaw.. Any such relative motion correspondingly decreases machining accuracy and repeatability and is therefore undesirable. The locating post 16 has a size and a position adapted for a sliding fit in an aperture in the head of a socket head threaded fastener 9 coupled to a hard jaw 8, as shown in the front view of a vise understop attached to a hard jaw 8 in FIG. 8 and also in cross section in FIG. 9. The position of the cross section in FIG. 9 is shown by the line marked A-A in FIG. 8. Alternately, the locating post 16 fits slidably into a socket head fastener used to attach a hard jaw to a floating vise jaw. The embodiment illustrated in FIG. 3, FIG. 4, and FIG. 8 has two locating posts 16, but other embodiments may have a different number and position of locating posts.

The understop side flange 12 is formed with a spring post channel 17 extending from a front surface of the understop side flange 12 to a back surface of the understop side flange 12. A spring post channel 17 provides clearance for an end of a spring post optionally used to hold a vise parallel against a hard jaw and against a vise understop. A shape and size of the spring post channel 17 are adapted for a clearance fit of a spring post. In the embodiment of FIG. 4, the spring post channel 17 has a semi-cylindrical shape. The spring post channel 17 may have other shapes in other embodiments. The understop side flange 12 is also formed with a clamping screw threaded aperture 15 as shown in FIG. 5. The clamping screw threaded aperture 15 has a size adapted to receive a threaded fastener such as a clamping screw 4 visible in FIG. 1.

A depth of the relocatable stop support shoulder 13, shown from above in FIG. 3 and from the front in FIG. 4, matches a thickness of the relocatable stop 3. By making the depth of the relocatable stop support shoulder 13 the same as the thickness of the relocatable stop 3, the understop body front surface 11 is approximately coplanar with a front surface of a relocatable stop 3 connected to the understop body 2. Coplanarity of the front surface of the relocatable stop 3 and the front surface of the understop body 2 is shown in FIG. 1 and in more detail in FIG. 9. Coplanarity of the two surfaces extends a range of heights of vise parallels that may be supported against a front side of the vise understop 1. The height of a vise parallel corresponds to a dimension in a vertical direction on a large face of a hard jaw. The height of a vise parallel is ordinarily selected to be slightly less than the height of a hard jaw so that a work piece resting on the top surface of the vise parallel also contacts a face of the hard jaw. The embodiment of FIG. 1 provides good support for vise parallels having a height in a range from somewhat greater than a height of the understop body 2 to a height somewhat less than a distance from a bottom edge of the understop body 2 to a top edge of a relocatable stop 3 connected to the understop body 2.

A portion of a side surface of the relocatable stop 3 projects above a top surface of a vise parallel to provide a contact area between the side surface of the understop 3 and an edge of a work piece. Contact between a side of the relocatable stop 3 and an edge of the work piece is necessary to establish a lateral reference position for the work piece. In the example of FIG. 8, a maximum height for a vise parallel (not illustrated) would be slightly less than the height shown for the hard jaw 8. In another example, a top surface of a relocatable stop projects about 0.02 inch (0.51 millimeter) above a top surface of a vise parallel but does not project above a top surface of the hard jaw.

The relocatable stop support shoulder 13 and a plurality of pin apertures 14 cooperate to form a set of discrete attachment positions for the relocatable stop 3 along a length of the understop body 2. The relocatable stop support shoulder 13 and pin apertures 14 are shown from the top of the understop body 2 in FIG. 3 and from the front in FIG. 4. The relocatable stop support shoulder 13 has a shape matching a shape of a corresponding bottom surface on the relocatable stop 3. In the embodiment of FIG. 4, the relocatable stop support shoulder 13 is formed with a surface having the profile of a serpentine curve. In other embodiments, the relocatable stop support shoulder 13 is formed with a flat surface or with other curve shapes.

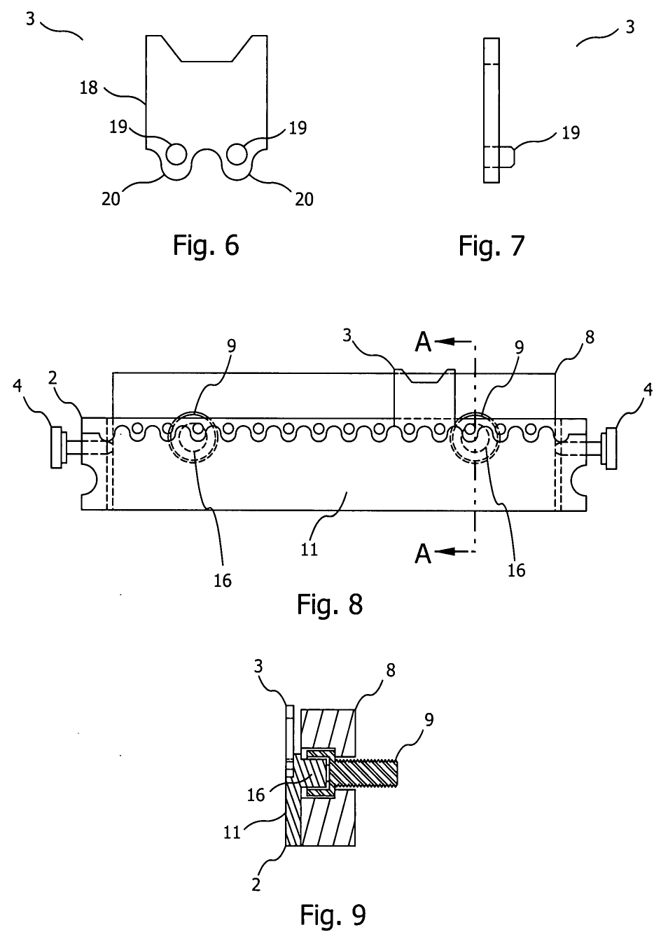

The pin apertures 14 in the understop body 2 have a size and a position adapted for a close sliding fit of a locating pin attached to a relocatable stop 3. A relocatable stop 3 is illustrated from the front in FIG. 6 and from the side in FIG. 7. In the embodiment of FIG. 6, a relocatable stop 3 comprises a relocatable stop plate 18 formed with two parallel, vertical sides and two relocatable stop locating bosses 20. A surface on a bottom side of the relocatable stop 3 has a shape that matches a shape of the relocatable stop support shoulder 13 on the understop body 2, as previously described. A locating pin 19 projects perpendicularly from a back surface of the relocatable stop 3. In the embodiment of FIG. 6, a relocatable stop 3 comprises two locating pins 19. Other embodiments have a different number, size, spacing, and position of locating pins.

A relocatable stop 3 is connected to an understop body 2 by slidably inserting the locating pins 19 on the relocatable stop 3 into corresponding pin apertures 14 on the understop body 2. In the embodiment illustrated in FIG. 1 and FIG. 4, twenty pin apertures 14 enable a relocatable stop 3 to be connected to the understop body 2 in one of nineteen separate locations. One skilled in the art will recognize that many different embodiments of the invention may be made by simple variations in parameters such as aperture spacing, number of apertures, number and spacing of locating pins, length of understop body, and so on.

A combination of the curved surface of the relocatable stop support shoulder 13, the corresponding curved surface forming part of the relocatable stop locating bosses 20 on the relocatable stop 3, the pin apertures 14, and the locating pins 19 are effective in reducing positioning error and improving repeatability of a position of the relocatable stop 3 relative to the understop body 2. Reduced positioning error and improved repeatability in a position of the relocatable stop 3 corresponds to an improvement in the accuracy of a machined work piece. Contacts between parts of the relocatable stop 3 and corresponding parts of the understop body 2 occur in more than one plane and more than one direction. A displacement of the relocatable stop 3 relative to the understop body 2 causes the locating pins 19 to bind in their corresponding pin apertures 14 and also causes firm contact between the relocatable stop support shoulder 13 and relocatable stop locating bosses 20, thereby limiting the displacement to a small value. In some embodiments, the contribution of relative motion between parts of the vise understop to errors in positioning and repeatability, corresponding to accuracy errors in a machined work piece, is 0.0002 inch (0.0051 millimeter) or less.

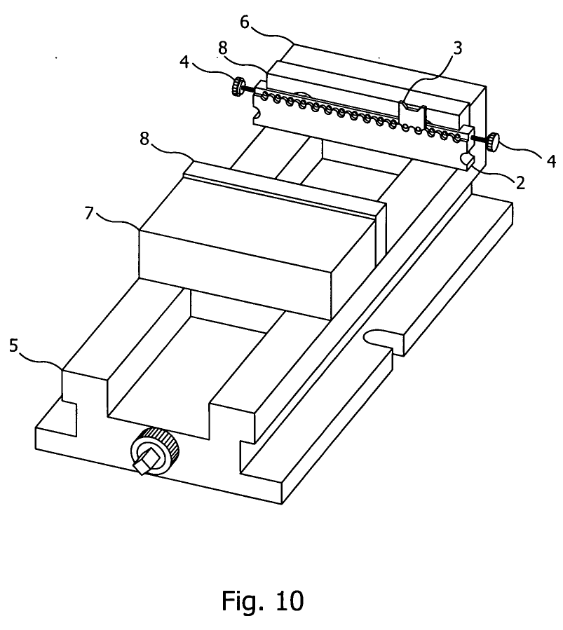

An example of a vise understop attached to a hard jaw 8 fastened to a fixed vise jaw 6 of a machine vise 5 appears in FIG. 10. A hard jaw 8 fastened to a floating vise jaw 7 is shown for reference. In the embodiment illustrated, the vise understop comprises an understop body 2, a relocatable stop 3 having a selectable position relative to the understop body 2, and two clamping screws 4 to firmly attach the vise understop to the hard jaw 8. The understop body 2 is further coupled to the hard jaw 8 by two locating posts on a back surface of the understop slidably inserted into two socket head threaded fasteners used to fasten the hard jaw 8 to the fixed vise jaw 6, as described previously. The locating posts and socket head threaded fasteners may not be visible after the vise understop is attached to the hard jaw 8 and are therefore not shown in FIG. 10.

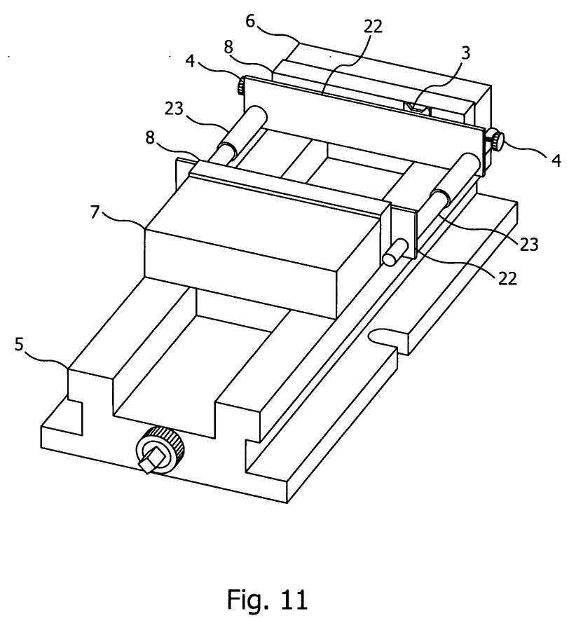

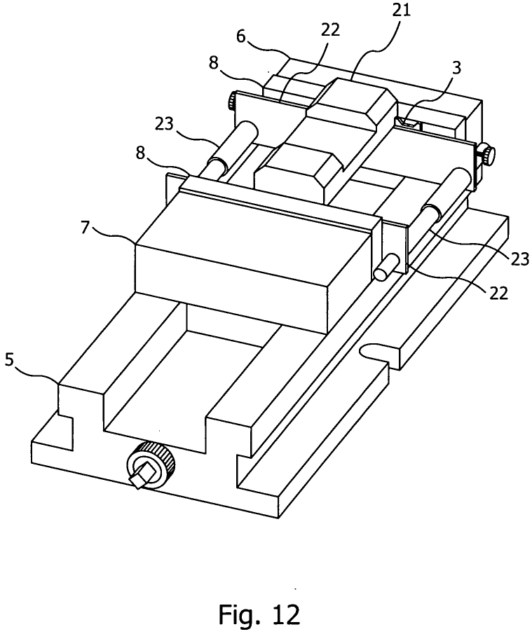

A pair of vise parallels 22 and a two spring posts 23 are added to the example of FIG. 10 in FIG. 11. A first vise parallel 22 is placed in contact with the understop body front surface and with a front surface of the relocatable stop 3. Only the uppermost part of the relocatable stop 3 is visible behind the first vise parallel 22. A second vise parallel 22 is placed against a face of the hard jaw 8 fastened to the floating vise jaw 7. Ordinarily, both vise parallels have the same height. The height of the vise parallels 22 establishes a vertical reference position for a work piece placed in contact with upper surfaces on both parallels. A position of a side of the relocatable stop 3 establishes a lateral reference position for a work piece having a side, or alternatively an edge, in contact with the side of the relocatable stop 3.

In the example of FIG. 11, the vise parallels are held against the vise understop and against the hard jaw on the floating vise jaw by two spring posts 22. An example of a spring post comprises two partially hollow cylinders, one slidably inserted in the other, with an expansion spring installed inside the nested cylinders. A shaft with a shoulder on each end of the spring post engages a hole in a vise parallel. The spring post channel 17 on the understop body, visible in FIG. 4 but hidden from view in FIG. 1, allows the shaft at the end of a spring post to protrude beyond the vise parallel 22 without interfering with the vise understop. The expansion spring inside the spring post exerts a force against the vise parallels to hold the vise parallels against the hard jaw 8 and also against the vise understop. Other means for holding the vise parallels in place include, but are not limited to, an expansion spring placed in the space between the vise parallels, magnetic holding means, clamps, clips, and other removable vise parallel holding means.

An example of a work piece 21 is added to the example of FIG. 11 in FIG. 12. The example of a work piece 21 is placed in contact with an upper surface on each of the two vise parallels 22, thereby establishing a vertical reference position for the work piece 21. An edge, or alternatively a surface, of the work piece 21 is placed in contact with a side of the relocatable stop 3, thereby establishing a lateral reference position for the work piece 21. In some applications, the vise understop 3 and hard jaws 8 protrude above a bottom surface of the work piece by 0.02 inch (0.51 millimeter) or less, corresponding to a very small obstructed region for a preferred path of a cutting tool.

The present disclosure is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, use of equivalent functional couplings for couplings described herein, or use of equivalent functional steps for steps described herein. Such insubstantial variations are to be considered within the scope of what is contemplated here. Moreover, if plural examples are given for specific means, or steps, and extrapolation between or beyond such given examples is obvious in view of the present disclosure, then the disclosure is to be deemed as effectively disclosing and thus covering at least such extrapolations.

Unless expressly stated otherwise herein, ordinary terms have their corresponding ordinary meanings within the respective contexts of their presentations, and ordinary terms of art have their corresponding regular meanings.

What is claimed is:

1. A device for positioning a work piece against a hard jaw of a machine vise, comprising:
an understop body comprising a right side, a left side, a front surface, a back surface, a relocatable stop support shoulder inset perpendicularly from said understop body front surface and having a common edge with said understop body front surface, and a plurality of discrete relocatable stop attachment positions separated at intervals along a length of said relocatable stop support shoulder;
a relocatable stop comprising a back surface, a bottom surface, and a locating pin projecting perpendicularly from said relocatable stop back surface;
wherein said understop body removably attaches to the hard jaw, said bottom surface of said relocatable stop removably contacts said relocatable stop support shoulder, a position of said relocatable stop is selectable from said plurality of discrete relocatable stop attachment positions; and
wherein a selectable position of said relocatable stop on said relocatable stop support shoulder defines a selectable lateral reference position for the work piece.

2. The device for positioning a work piece against a hard jaw of a machine vise as in claim 1, further comprising:
a left-side flange attached to said understop body left side at a right angle to said understop body front surface;
a right-side flange attached to said understop body right side at a right angle to said understop body front surface;
a threaded clamping fastener for attaching said understop body to the hard jaw;
wherein said left-side flange is formed with a threaded aperture adapted to fit said threaded clamping fastener, said right-side flange is formed with a threaded aperture adapted to fit said threaded clamping fastener, a first threaded clamping fastener is cooperatively assembled to said threaded aperture in said right-side flange, and a second threaded clamping fastener is cooperatively assembled to said threaded aperture in said left-side flange.

3. The device for positioning a work piece against a hard jaw of a machine vise as in claim 2, further comprising:
a locating post projecting perpendicularly from said back surface of said understop body;
a socket head threaded fastener for attachment of the hard jaw to the vise, said socket head threaded fastener having an aperture formed in an end; and
wherein said locating post has a size and a position on said back surface of said understop body adapted for a sliding fit into said aperture in said socket head threaded fastener.

4. The device for positioning a work piece against a hard jaw of a machine vise as in claim 3, wherein said relocatable stop support shoulder has an edge with a curved shape, said relocatable stop bottom surface has an edge with a curved shape, and said relocatable stop support shoulder edge curved shape and said relocatable stop bottom surface edge curved shape are the same.

5. The device for positioning a work piece against a hard jaw of a machine vise as in claim 4, wherein said right-side flange is formed with a right-side spring post channel, said right-side spring post channel having an axis perpendicular to said understop body front surface, said left-side flange is formed with a left-side spring post channel, said left-side spring post channel having an axis parallel to said axis of said right-side spring post channel, and said right-side and left side spring post channels having a shape adapted for a clearance fit of a spring post.

6. The device for positioning a work piece against a hard jaw of a machine vise as in claim 3, wherein said relocatable stop bottom surface edge curved shape and said relocatable stop support shoulder edge curved shape are a serpentine curve having peaks at equal intervals along said length of said relocatable stop support shoulder.

7. The device for positioning a work piece against a hard jaw of a machine vise as in claim 6, wherein a depth of said relocatable stop support shoulder and a thickness of said relocatable stop are the same.

8. The device for positioning a work piece against a hard jaw of a machine vise as in claim 7, further comprising a vertical surface having a position between said understop body front surface and said understop body back surface, wherein said vertical surface has an edge in common with said relocatable stop support shoulder, said vertical surface is formed with a plurality of pin apertures extending through said vertical surface and said understop body back surface, and said pin apertures are adapted for a sliding fit of said locating pin.

9. The device for positioning a work piece against a hard jaw of a machine vise as in claim 8, further comprising:
a left-side flange inner surface perpendicular to said understop body back surface, said left-side flange inner surface facing said right-sight flange;
a right-side flange inner surface perpendicular to said understop body back surface, said right-side flange inner surface facing said left-sight flange; and
wherein a separation distance between said left-side flange inner surface and said right-side flange inner surface is adapted for a loose sliding fit of a length dimension of a hard jaw.

10. The device for positioning a work piece against a hard jaw of a machine vise as in claim 9, further comprising a vise parallel in removable contact with said front surface of said understop body.

11. The device for positioning a work piece against a hard jaw of a machine vise as in claim 10, further comprising a machine vise in removable contact with a surface of said understop body.

12. A method for defining a repeatable reference position for a work piece held in a machine vise, comprising:
attaching an understop body to a first hard jaw attached to the fixed vise jaw of a machine vise;
selecting a preferred location for a relocatable stop on the understop body;
connecting the relocatable stop to the understop body at the preferred location;
selecting a first vise parallel having a height greater than a height of the understop body and less than a combined height of the understop body and relocatable stop;
placing a large face of the first vise parallel in contact with the understop body and the relocatable stop;
selecting a second vise parallel having a height the same as the height of the first vise parallel;
placing a large face of the second vise parallel in contact with a face of a second hard jaw;
placing a bottom surface of a work piece in contact with a top surface of the first vise parallel;
placing the bottom surface of the work piece in contact with a top surface of the second vise parallel;
adjusting a position of the workpiece on the top surfaces of the first and second vise parallels until an edge of the work piece contacts a side of the relocatable stop; and
adjusting a separation distance between the first and second hard jaws until the work piece is held securely against the first hard jaw, the second hard jaw, the first vise parallel, the second vise parallel, and the relocatable stop.
